(19) United States
(12) Patent Application Publication
(10) Pub. No.: US 2012/0296817 A1
(43) Pub. Date: Nov. 22, 2012

(54) SYSTEMS AND METHODS FOR PROMOTING PRODUCTS AND SERVICES

(76) Inventors: KEN R. POWELL, Watkinsville, GA (US); JOHN W. DANIEL, Watkinsville, GA (US)

(21) Appl. No.: 13/112,971

(22) Filed: May 20, 2011

(51) Int. Cl. G06Q 40/00

(52) U.S. Cl. 705/40; 705/44

(57) ABSTRACT

Disclosed are systems and methods for promoting products and services in a retail environment.

### FIELD OF THE INVENTION

This invention relates generally to systems and methods for promoting products and services and, more particularly, to systems and methods for promoting products and services in a retail environment.

### SUMMARY OF THE INVENTION

According to an aspect of the present invention, there is a method for operating with a system including a first entity and a payment entity. The first entity provides retail services. The first entity effectively sends an authorization inquiry message to the payment entity, the authorization inquiry message being in a first format; and receives a reply message from the payment entity, the reply message being in a second format. The payment entity provides payment services. The payment entity performs the steps of receiving a message, from the first entity, in the first format; and responsive to the message received in the receiving step, constructing a message in the second format, such that a content of the message in the second format depends on whether an account of a consumer can effect payment. The method comprises the steps of electronically receiving an authorization inquiry message from the first entity, the authorization inquiry message being in the first format; responsive to the message received in the receiving step, electronically constructing a reply message in the second format, such that a content of the message in the second format depends on whether a product promotional offer is applicable; and electronically sending the reply message to the first entity, to cause circuitry in the first entity to behave as if the message came from the payment entity.

According to another aspect of the present invention. There is a method for operating with a system including a first entity and a payment entity. The first entity provides retail services. The first entity activates first circuitry that sends a message to the payment entity, the message including a first field, and second circuitry that receives a reply message from the payment entity, the reply message being in a second format. The payment entity provides payment services, the payment entity performing the steps of receiving a message including the first field, from the first entity; comparing the first field to a threshold; responsive to the comparing step; and constructing a message in the second format. The method comprises the steps of electronically receiving a message including the first field, from the first entity; searching for a data item by using the first field; responsive to the searching step, electronically constructing a reply message in the second format; and electronically sending the reply message to the first entity.

According to yet another aspect of the present invention. There is a promotion system for operating with a financial system including a first entity and a payment entity, the first entity providing retail services, wherein the first entity activates first circuitry that sends a message to the payment entity, the message including a first field, and second circuitry that receives a reply message from the payment entity, the reply message being in a second format. The payment entity provides payment services, the payment entity performing the steps of receiving a message including the first field, from the first entity; comparing the first field to a threshold; responsive to the comparing step; and constructing a message in the second format. The promotion system comprises circuitry configured to receive a message including the first field, from the first entity; search for a data item by using the first field; construct a reply message in the second format; and send the reply message to the first entity.

According to yet another aspect of the present invention. There is a promotion system for operating with a financial system including a first entity and a payment entity, the first entity providing retail services, wherein the first entity activates first circuitry that sends a message to the payment entity, the message including a first field, and second circuitry that receives a reply message from the payment entity, the reply message being in a second format. The payment entity provides payment services, the payment entity performing the steps of receiving a message including the first field, from the first entity; comparing the first field to a threshold; responsive to the comparing step; and constructing a message in the second format. The promotion system comprises means for receiving a message including the first field, from the first entity; means for earching for a data item by using the first field; means for constructing a reply message in the second format; and means for sending the reply message to the first entity.

### BRIEF DESCRIPTION OF THE DRAWINGS

References are made to the following text taken in connection with the accompanying drawings, in which:

FIG. 1 shows an exemplary system according to an embodiment of the present invention.

FIG. 2 is a diagram showing people and circuitry within a merchant building.

FIG. 3 is a diagram of a conventional card reader terminal.

FIGS. 4A and 4B show a card used in a settlement process with multiple customers.

FIGS. 5A and 5B show a payment card used by a customer.

FIGS. 6A and 6B show a payment card used by another customer.

FIG. 7 shows configurations of computer networks in a first exemplary system.

FIG. 8 is a sequence diagram.

FIG. 9 is a flow chart of a process performed in the first exemplary system.

FIG. 10 is a flowchart of another process performed in the first exemplary system.

FIG. 11 is a diagram showing aspects of a data structure used for processing promotions.

FIG. 12 is a diagram showing circuitry in the first exemplary system.

FIG. 13 is a diagram for describing a parsing operation of a message received by an exemplary promotion processor.

FIG. 14 is a diagram for describing an authorization message sent to a conventional bank that issued a payment card.

The accompanying drawings which are incorporated in and which constitute a part of this specification, illustrate embodiments of the invention and, together with the description, explain the principles of the invention, and additional advantages thereof. Certain drawings are not necessarily to scale, and certain features may be shown larger than relative actual size to facilitate a more clear description of those features. Throughout the drawings, corresponding elements are labeled with corresponding reference numbers.

### DETAILED DESCRIPTION OF EXEMPLARY SYSTEMS

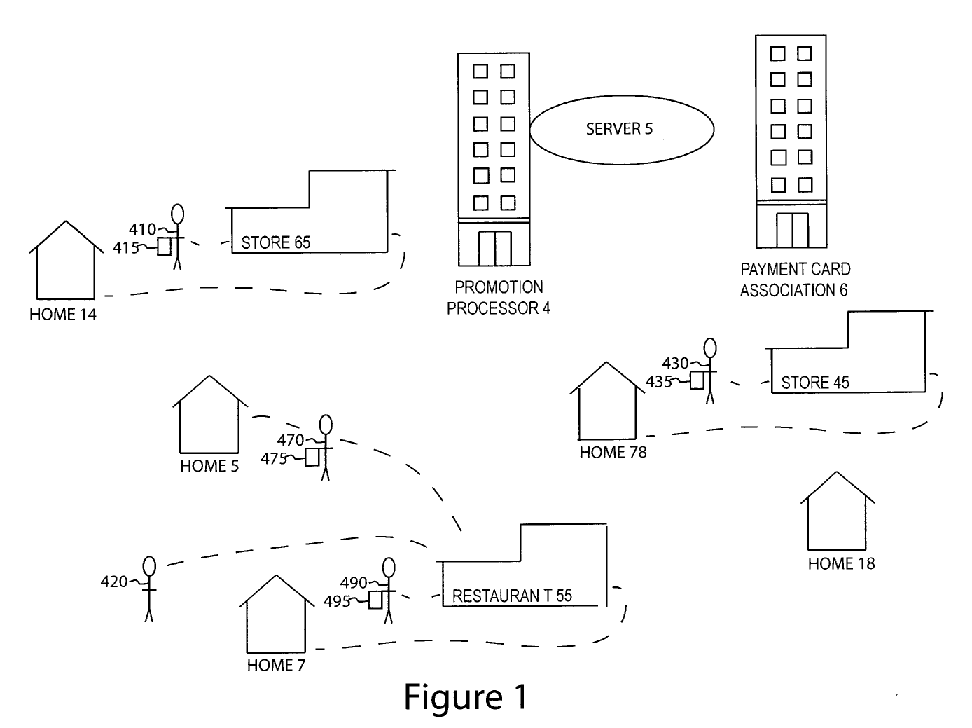

FIG. 1 shows system 1 according to an exemplary embodiment of the present invention. System 1 includes multiple persons, such as person 410, person 420, person 430, person 470, and person 490. System 1 includes a promotion offer processor 4 that operates a server 5. Server 5 receives signals from and send signals to persons 410, 430, 470, 420, and 490.

Processor 4 and retail store 45 are non-affiliated, meaning that they are not affiliates with respect to each other. In this patent application, concerns are affiliates of each other when one concern controls or has the power to control the other, or a third party or parties controls or has the power to control both. Power to control is described in Section 121 of the U.S. regulations of the Small Business Administration.

Processor 4 and restaurant 55 are non-affiliated.

Processor 4 and retail store 65 are non-affiliated.

Store 45 and restaurant 55 are non-affiliated.

Store 45 and store 65 are non-affiliated.

Restaurant 55 and store 65 are non-affiliated.

Person 490 resides in home 7. While in home 7, person 490 manipulates a control on portable telephone 495 to request a description of available promotional offer or offers and then portable telephone 495 receives the description of the promotional offer or offers via a mobile phone communication signal. In this example, the request for the description of available promotional offers happens outside of the retail stores. A promotional offer is an offer provided to induce a person such as person 490 to purchase goods or services and a promotional offer may be in the form of an electronic coupon where the price of the product purchased is to be reduced by a specified amount, an electronic voucher where a person such as person 490 has purchased a product or service at a discounted price and the voucher is provided to confirm the person purchased the product or service, or a loyalty event where a person such as person 490 is provided with a discount off of goods or services event for engaging in an activity or series of activities set by the offeror of the promotional offer as required to realize the redemption of a reward. Redemption of a coupon, redemption of a voucher, and redemption of a loyalty event are each a type of reward.

From the description of available promotional offer or offers displayed on her portable telephone, person 490 selects the desired promotional offer or offers. Person 490 selects a promotional offer. Person 490 could select the promotion offer by selecting a hyperlink in a HyperText Markup Language (HTML) document received from server 5. In response to the selection of the hyperlink, server 5 sends text to portable telephone 495. The sent text includes an offer code including multiple digits: 374.45. This offer code can be effective in restaurant 55 and not effective in establishments non-affiliated with restaurant 55.

Person 470 resides in home 5. While outside of home 5, person 490 manipulates a control on portable telephone 475 to request a description of available promotional offer or offers and then portable telephone 475 receives the description of the promotional offer or offers via a mobile phone communication signal. From the description of available promotional offer or offers displayed on his portable telephone, person 470 selects the desired promotional offer or offers. Person 470 selects a promotional offer. Person 470 could select the promotion offer by selecting a hyperlink in an HTML document received from server 5. In response to the selection of the hyperlink, server 5 sends text to portable telephone 475. The sent text includes an offer code including multiple digits: 2371.05. This offer code can be effective in restaurant 55 and not effective in establishments non-affiliated with restaurant 55.

Subsequently, person 470 goes to restaurant 55, carrying his portable telephone 475.

Person 420 goes to restaurant 55.

Person 410 resides in home 14. Person 410 manipulates a control on portable telephone 415 to request a description of available promotional offer or offers and then portable telephone 415 receives the description of the promotional offer or offers via a mobile phone communication signal. From the description of available promotional offer or offers displayed on her portable telephone, person 410 selects the desired promotional offer or offers. A selected offer may be applicable to store 65 and non applicable to establishments non-affiliated with store 65. Person 410 selects a promotional offer. Person 410 could select the promotion offer by selecting a hyperlink in an HTML document received from server 5. In response to the selection of the hyperlink, server 5 sends text to portable telephone 415. The sent text includes an offer code including multiple digits: 37.14. This offer code can be effective in retail store 65 and not effective in establishments non-affiliated with retail store 65.

Subsequently, person 410 goes to store 65, carrying her portable telephone 415.

Person 430 resides in home 78. Person 430 manipulates a control on portable telephone 435 to request a description of available promotional offer or offers and then portable telephone 435 receives the description of the promotional offer or offers via a mobile phone communication signal. From the description of available promotional offer or offers displayed on her portable telephone, person 430 selects the desired promotional offer or offers. A selected offer may be applicable to store 45 and non applicable to establishments non-affiliated with store 45. Person 430 selects a promotional offer. Person 430 could select the promotion offer by selecting a hyperlink in an HTML document received from server 5. In response to the selection of the hyperlink, server 5 sends text to portable telephone 435. The sent text includes an offer code including multiple digits: 141.02. This offer code can be effective in store 55. Subsequently, person 430 goes to store 45, carrying her portable telephone 435.

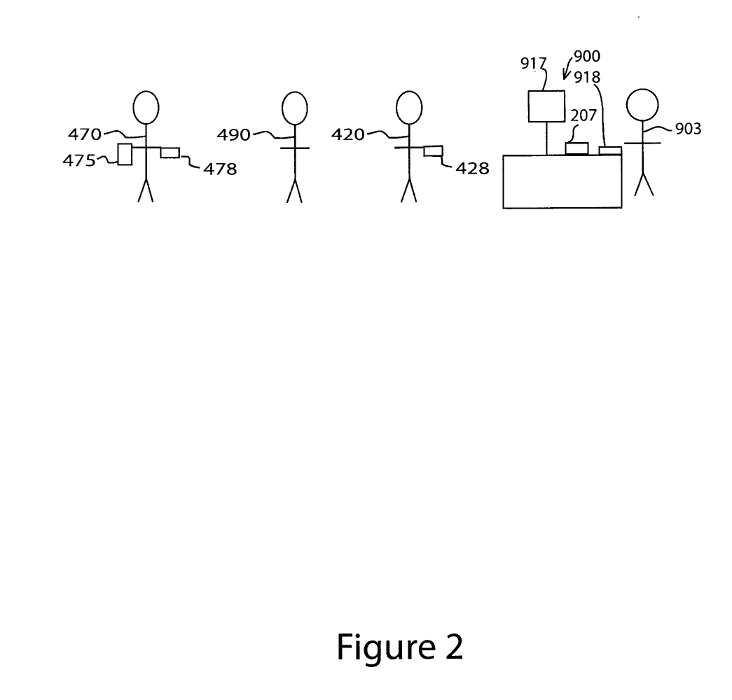

FIG. 2 is a partial view of restaurant 55 including cashier station 900. Station 900 includes a cash receipt drawer, a payment card reader terminal 207, a keyboard 918, and a display 917.

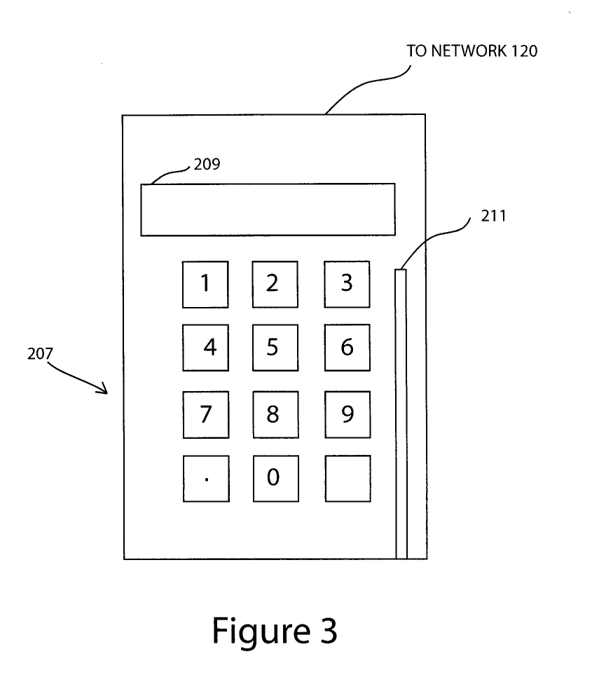

FIG. 3 shows payment card reader terminal 207 in more detail. Card reader terminal 207 includes a keyboard, a display 209, and a slot 211 containing a magnetic stripe reader

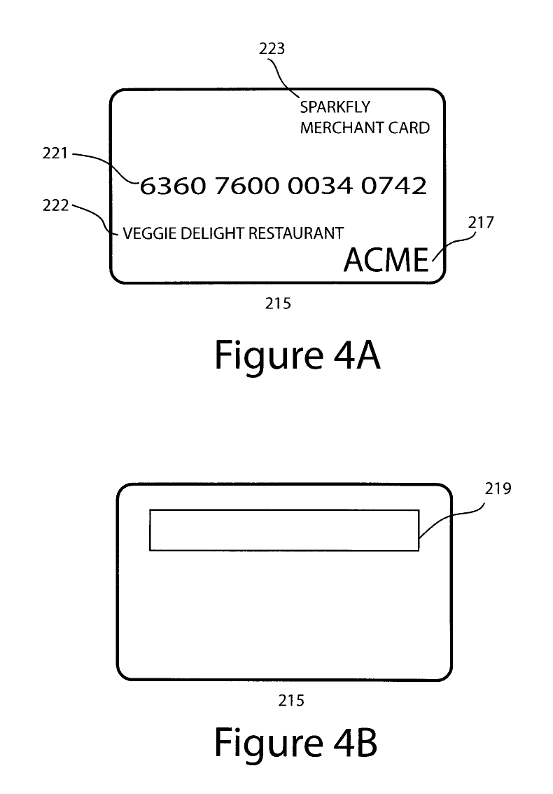

FIG. 4A shows a front, plan view of card 215 used by cashier 903, who is responsible for monitoring whether proper payment is received from each of persons 470, 490, and 420. The face of card 215 presents a card number 221, the name 222 of restaurant 55, “VEGGIE DELIGHT RESTAURANT”, and a name 223 of promotion processor 4, “SPARKFLY”.

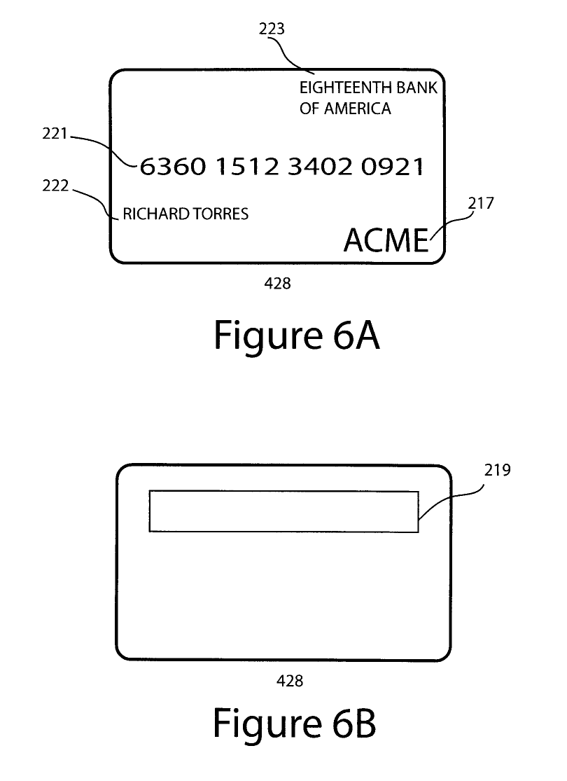

FIG. 6B shows a back, plan view of card 215. Card 215 includes magnetic stripe 219 storing the ID number and other information on the reverse side. Tracks of stripe 219 also store the number 636076, indicating a card associated with ACME, in accordance with International Standard ISO 7812.

Each customer is processed by cashier station 900. Customer 490 orally communicates her code, 374.45, to cashier 903 manning cashier station 900. In response to learning the promotion code from customer 490, cashier 903 swipes merchant card 215 through card reader slot 211 of card reader terminal 207, causing card reader terminal 207 to read the data on magnetic stripe 219. Cashier 903 also enters the promotion code, 374.45, using the keyboard of card reader terminal 207. Card reader terminal 207 then sends data read from magnetic stripe 219 and data read from the keyboard to promotion processor 4, via payment card association 6, as described in more detail below. Promotion processor 4 determines whether the promotional offer code is valid and if it is valid then sends an indication result that may or may not contain instructions to adjust the amount due by Consumer 490 based upon the terms of the promotional offer. The indication result is displayed on display 209 of card reader terminal 207. The indication result may be a digital code or text indicating “APPROVED” or text “DECLINED”. The indication result may also include additional information useful for Cashier 903 or Consumer 490 or both Cashier 903 and Consumer 490.

Cashier 903 determiners an amount due from customer 490 and conditionally lowers an amount due, depending on the indication result received.

Customer 470 orally communicates her code, 2371.05, to station 900, by presenting portable telephone 475 to station 900. Cashier 903 then swipes merchant card 215 through card reader slot 211 of card reader terminal 207, causing card reader terminal 207 to read the data on magnetic stripe 219. Cashier 903 also enters the promotion code, 2371.05, using the keyboard of card reader terminal 207. Card reader terminal 207 then sends data read from magnetic stripe 219 and data read from the keyboard to promotion processor 4, via payment card association 6, as described in more detail below. Promotion processor 4 determines whether the promotional offer code is valid and if it is valid then sends an indication result that may or may not contain instructions to adjust the amount due by customer 470 based upon the terms of the promotional offer. The indication result is displayed on display 209 of card reader terminal 207. The indication result may be a digital code or text indicating “APPROVED” or “DECLINED”. The indication result may also include additional information useful for Cashier 903 or Consumer 470 or both Cashier 903 and Consumer 470.

Cashier 903 conditionally lowers an amount due, depending on the indication result received.

Person 470 tenders payment of the amount due, by presenting credit card 478 to station 900. Cashier 903 or person 470 swipes card 478 through card reader slot 211 of card reader terminal 207, causing card reader terminal 207 to read the data on magnetic stripe 219 of card 478. Card reader terminal 207 then sends data read from magnetic stripe 219 of card 478 and data encoding the amount due to issuing bank 16, via payment card association 6. Issuing bank 16 determines whether credit card 478 can effect payment and sends a result. The result is displayed on display 209 of card reader terminal 207. The result may be a digital code or text indicating “APPROVED” or “DECLINED”.

Person 420 settles his meal transaction in restaurant 55 without using a promotion offer. Person 420 tenders payment of an amount due by presenting credit card 428 to station 900. Cashier 903 or person 420 swipes card 428 through card reader slot 211 of card reader terminal 207, causing card reader terminal 207 to read the data on magnetic stripe 219 of card 428. Card reader terminal 207 then sends data read from magnetic stripe 219 of card 428 and data encoding the amount due to issuing bank 18, via payment card association 6. Issuing bank 18 determines card 428 can effect payment and sends a result. The result is displayed on display 209 of card reader terminal 207. The result may be a digital code or text indicating “APPROVED” or text “DECLINED”.

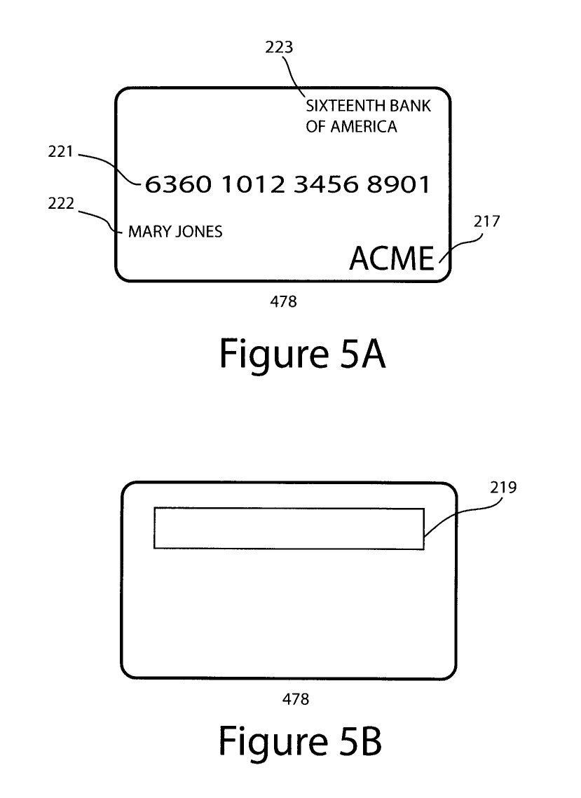

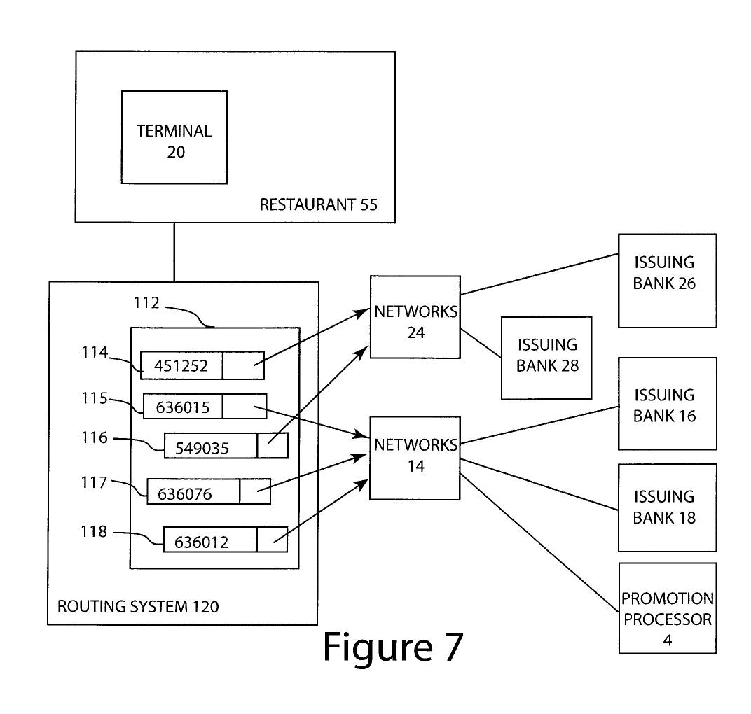

FIG. 5A shows a front, plan view of card 478 branded for a payment service offered by ACME, an operator of networks 14 (FIG. 7). More specifically, card 478 includes a prominent service mark 217, “ACME”. The face of card 478 also presents a card number 221, the name 222 of person 470, “MARY JONES”, and the name 223 of the issuing bank, “SIXTEENTH BANK OF AMERICA”.

FIG. 5B shows a back, plan view of card 478. Card 478 includes magnetic stripe 219 storing the ID number and other information on the reverse side. Tracks of stripe 219 also store the number 636010, indicating a card associated with ACME, in accordance with International Standard ISO 7812.

FIG. 6A shows a front, plan view of card 428 branded for a payment service offered by ACME, an operator of networks 14. More specifically, card 428 includes a prominent service mark 217, “ACME”. The face of card 478 also presents a card number 221, the name 222 of person 420, “RICHARD TORRES”, and the name 223 of the issuing bank, “eighteenth BANK OF AMERICA”.

FIG. 6B shows a back, plan view of card 428. Card 428 includes magnetic stripe 219 storing the ID number and other information on the reverse side. Tracks of stripe 219 also store the number 636015, indicating a card associated with ACME, in accordance with International Standard ISO 7812

System 1 includes system 5, which communicates with retailers 6, 10, and 11, via routing system 120. Services from payment processors—such as First Data, RBS Lynk, and Fifth Third—may be configured to implement routing system 120.

FIG. 7 shows another aspect of the first exemplary system, including routing system 120. Routing system 120 includes a data structure 112, accessed by programs in routing system 120. Data structure 112 allows routing system 120 to select the path of a transaction request packet received from a retailer, as a function of a routing field in the packet. The routing field may contain an issuer identification number (IIN). For example, when routing system 120 receives a transaction request packet containing the number 451252 in the routing field, routing system 120 accesses entry 114, to send the packet to card issuing bank 26, via communication networks 24, allowing card issuing bank 26 to authorize a credit card transaction. Communication networks 24 could be operated by a payment card association such as VISA Corporation and/or MasterCard Corporation.

When routing system 120 receives a transaction request packet containing the number 636076 in the routing field, routing system 120 accesses entry 117, to send the packet to promotion processor 4, via communication networks 14, enabling promotion processor 4 to confirm that a promotion code is valid. When routing system 120 receives a transaction request packet containing the number 636015 in the routing field, routing system 120 accesses entry 115, to send the packet to issuing bank 18, via communication networks 14, enabling issuing bank 18 to authorize a debit card transaction. Communication networks 14 may be operated by a payment card association.

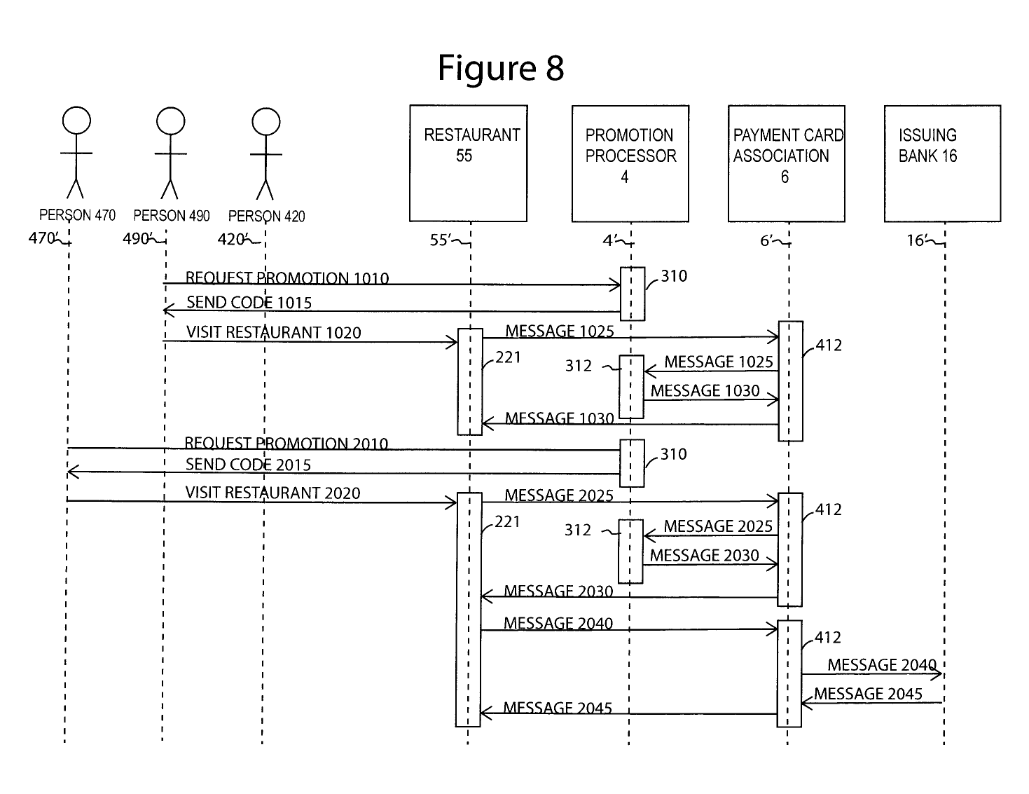

FIG. 8 is a sequence diagram showing sequences of messages and materials exchanged between people, data, and electronic processors in system 1. In FIG. 8, and in each of the other sequence diagrams in this patent application, each of the rectangles on a dashed line is a process invoked in response to a received message. The process could be facilitated, enabled, or carried out, by a computer executing computer instructions to effect a function of the process.

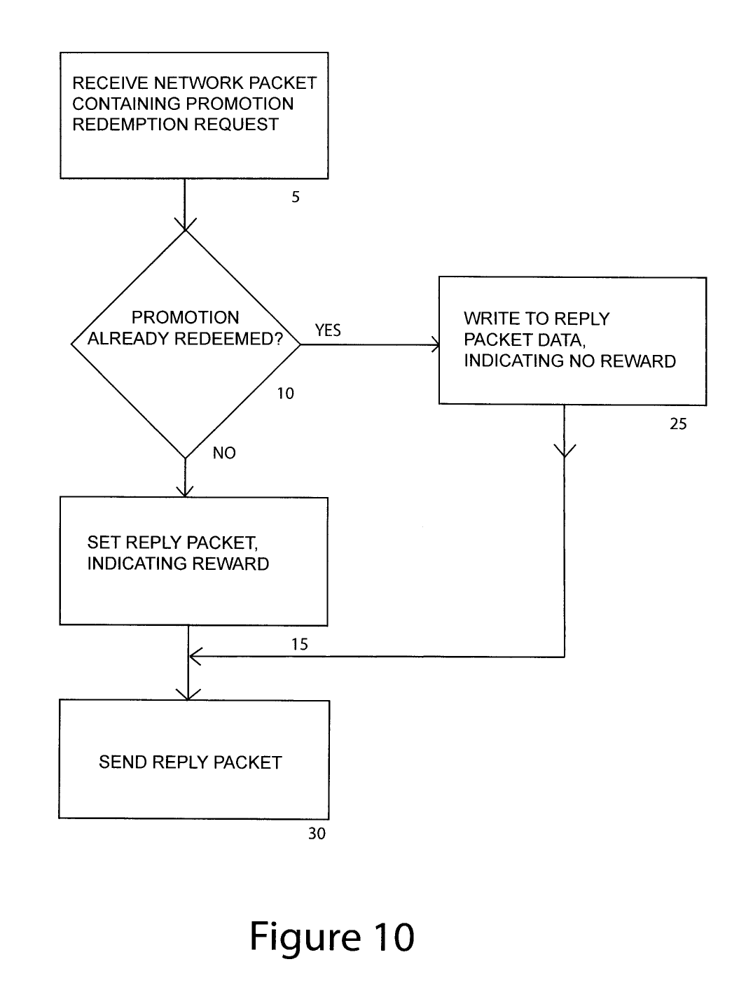

Person 490 requests a promotion by clicking on a hyperlink in a website document generated by promotion processor 4 (message 1010). Promotion processor 4 responds by generating a textual code and sending the code, in a HTTP formatted packet, to the portable device 495 carried by a person 490 (message 1015). Subsequently, person 490 visits restaurant 55 (message 1020). Cashier 903 in restaurant 55 swipes merchant card 215 and enters the promotion code, sent in message 1015, manually on the card reader terminal 207, thereby generating message 1025 and sending message 1025 to payment card association 6, via network 120. Payment card association 6, by means of communication networks 14, relays message 1025 to promotion processor 4. In response to receiving message 1025, promotion processor 4 performs the processing shown in FIG. 10, to generate a response of message 1030 to restaurant 55 via networks 14 operated by payment card association 6.

Person 470 requests a promotion by clicking on a hyperlink in a website document generated by promotion processor 4 (message 2010). Promotion processor 4 responds by generating a textual code and sending the code, in a HTTP formatted packet, to the portable electronic device 470 carried by a person 470 (message 2015). Subsequently, person 470 visits restaurant 55 (message 2020). Cashier 903 in restaurant 55 swipes merchant card 215 and enters the promotion code sent in message 2015 manually on the card reader terminal 207, thereby generating message 2025 and sending message 2025 to payment card association 6, via network 120. Payment card association 6, by means of communication networks 14, relays message 2025 to promotion processor 4. In response to receiving message 2025, promotion processor 4 performs the processing shown in FIG. 10, to generate a response of message 2030 to restaurant 55 via networks 14 operated by payment card association 6.

Subsequently, person 470 tenders payment, which in this case is $14.99, using payment card 478. Cashier 903 or person 470 swipes payment card 478 on the card reader terminal 207, and cashier 903 enters the payment amount, $14.99, manually on the card reader terminal 207 thereby generating message 2040 and sending message 2040 to payment card association 6, via network 120. Payment card association 6, by means of communication networks 14, relays message 2040 to issuing bank 16. In response to receiving message 2040, issuing bank 16 determines whether card 478 can effect payment, to generate a response of message 2045 to restaurant 55 via networks 14 operated by payment card association 6.

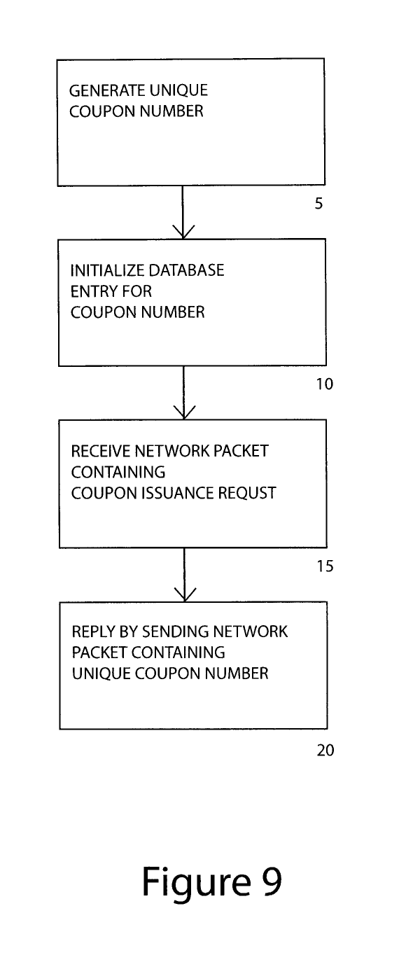

FIG. 9 shows a processing performed by process 310 (FIG. 8) in system 1. Process 310 generates a unique promotional code, to be issued to only one consumer at a time (step 5). Process 310 initializes a database entry for the unique promotional code: PROMOTION-ID-LIST [offer_number, redeemed]=false. (Step 10).

Process 310 receives a network packet containing a request to receive the information required to accept and use a promotional offer, originating from a portable electronic device such as portable telephone 495 carried by consumer 490. (Step 15). Process 310 replies to the packet received in step 15, by sending a reply packet containing a unique promotional offer code to the portable electronic device.

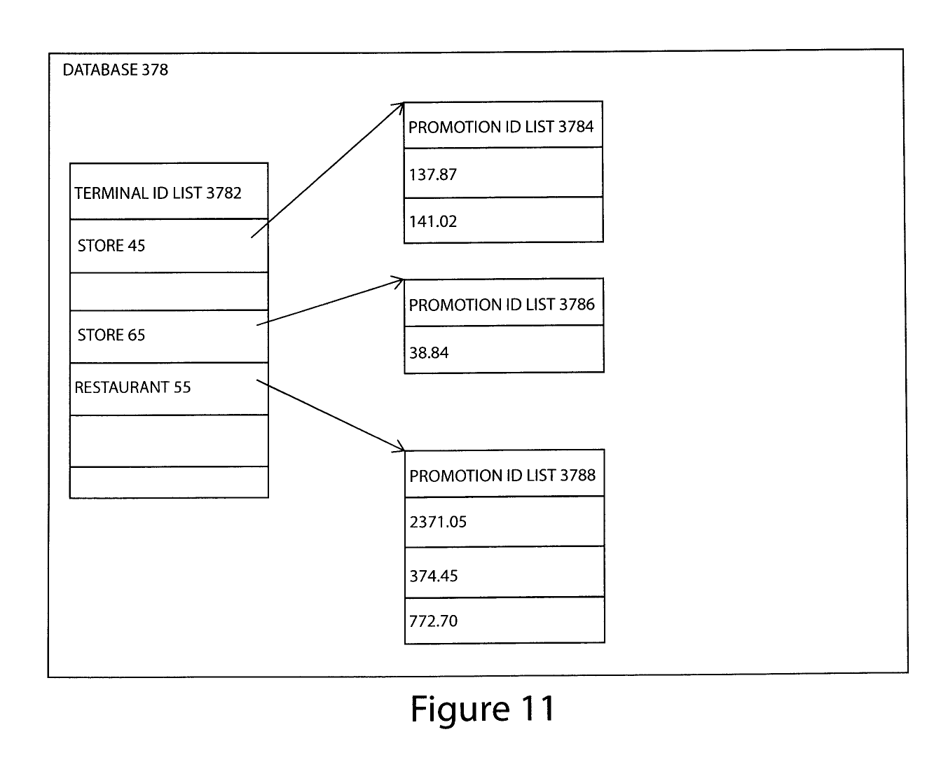

FIG. 10 shows a processing performed by process 312 (FIG. 8). Process 312 receives a network packet including data in ISO 8583 format, constituting a request to determine if a promotional code is valid for a merchant, such as restaurant 55. Process 312 selects a promotion ID list (FIG. 11) by reading ISO 8583 data elements 41 or 42, which act as a merchant ID, received in a packet such as that for message 1025 or message 2025. Process 312 determines whether the promotional offer code is available: PROMOTION-ID-LIST [offer_number, available]=true? (Step 10). If the promotional offer is available for use process 312 sets reply packet data to indicate that a redemption is authorized (see step 15).

If the requested promotional offer has already been redeemed or is otherwise unavailable to the specific consumer at that time, server 5 sets reply packet data to indicate a redemption is not authorized (Step 25).

Process 312 sends the reply packet to the retail store that sent the promotional offer code redemption request (step 30).

Each of stores 45 and 65 includes the circuitry having the functionality of the circuitry in restaurant 55.

In this patent application, the word circuitry encompasses dedicated hardware, and/or programmable hardware, such as a CPU or reconfigurable logic array, in combination with programming data, such as sequentially fetched CPU instructions or programming data for a reconfigurable array.

### MORE DETAILED DESCRIPTION

Message 1025 sent to promotion processor 4, message 2025 sent to promotion processor 4, and message 2040 sent to issuing bank 16 each includes ISO 8583-formatted data. Each of messages 1025, 2025, and 2040 includes a Message Type Indicator (MTI), one or more bitmaps, indicating which data elements are present, and data elements constituting the fields of the message.

The MTI includes a 4 digit numeric field that classifies the high level function of the message. A message type indicator includes the ISO 8583 version, the Message Class, the Message Function and the Message Origin.

Position 2 of the MTI specifies the overall purpose of the message. Each of messages 1025, 2025, and 2040 includes a 1 in position 2 (x1xx), meaning that it is an authorization message: get an approval but do not post to account for reconciliation.

Data elements are the individual fields carrying the transaction information. Each data element is described in a standard format which defines the permitted content of the field (numeric, binary, etc.) and the field length (variable or fixed), according to the following table: Each of messages 1025, 2025, and 2040 includes data element 4, which a 12 digit transaction amount. Each of messages 1025, 2025, and 2040 includes data element 41, which is a 16 characters card acceptor terminal identification; or data element 42, which is a 15 character card acceptor identification code.

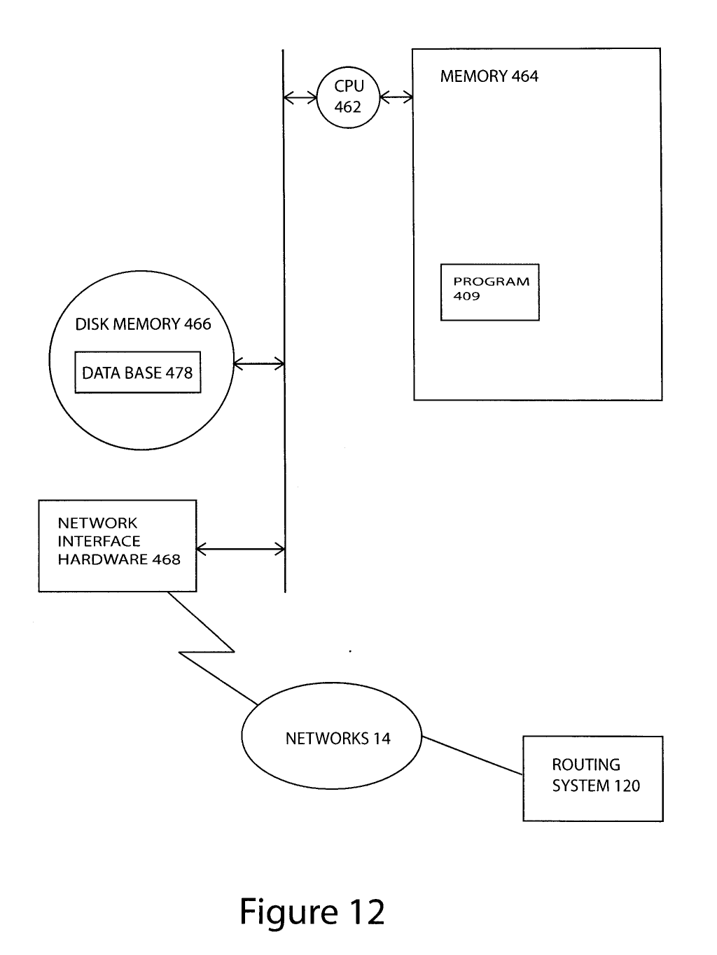

FIG. 12 shows another aspect of promotion processor 4. Promotion processor 4 includes central processing unit (CPU) 462, random access memory 464, disk memory 466 for storing programs and data, and network interface hardware 468.

CPU 462 executes programs stored in memory 464, to process received ISO 8583 messages, and to generate and send ISO 8583 messages from promotion processor 4.

Database 478 is stored on magnetic disk 466, and portions of database 478 are read into memory 464 as needed.

CPU 462 executes program 409 (a plurality of computer instructions) to effect process 312 (FIG. 8).

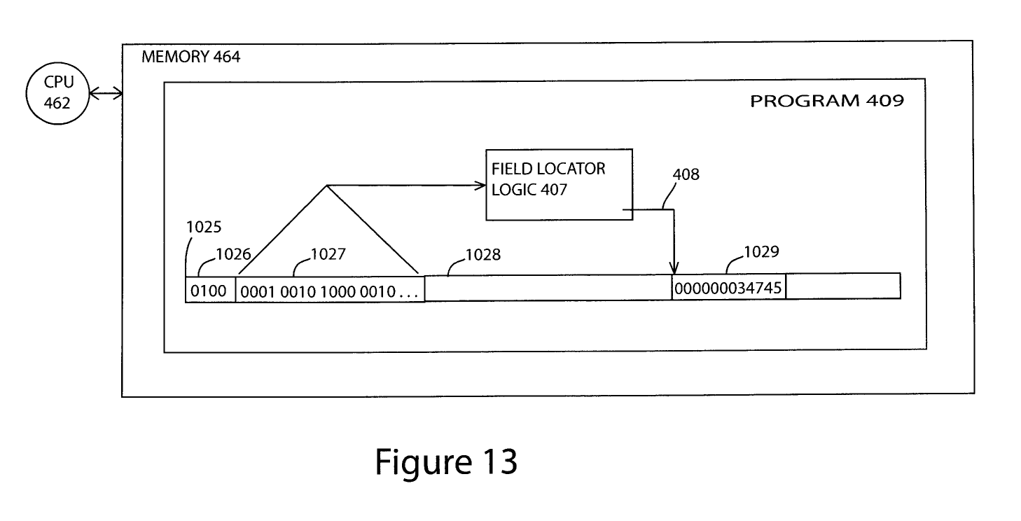

FIG. 13 is a diagram describing an aspect of program 409. Program 409 locates ISO 8583 field 4, indicating a transaction amount, by reading bitmap field 1027

As shown in FIG. 13, program 409 processes message 1025 received by promotion process 4, from restaurant 55 via the networks of payment card associations 6.

Message Type Indicator (MTI) field 1026 contains 0100, indicating an authorization request message.

Bitmap field 1027 indicates which other data elements or data element subfields may be present in data elements 1028. Bitmap field 1027 includes 1 in the fourth bit position, indicating that the ISO 8583 transaction amount field 4 (reference 1029) is present in data elements 1028. Transaction amount field for 1029 contains 34745, which is the promotion code value being employed by person 490 in restaurant 55.

Field locator logic 407 is a subpart of program 409. Field locator logic 407 reads bitmap 1027 in order to generate data element 408, which is effectively a reference or memory address pointer to ISO 8583 transaction amount field 1029, which in this case contains the code 34745 being employed by person 490 in restaurant 55.

In summary, an exemplary embodiment of the invention operates in the context of a merchant, such as restaurant 55 and a payment entity, such as an issuing bank. Restaurant 55 activates circuitry that sends messages, such as message 2040, to the issuing bank, the message including the ISO 8583 transaction amount field 1029. The issuing bank performs the steps of receiving the message from restaurant 55; and comparing a content of the ISO 8583 transaction amount field to a consumer's limit. These actions of restaurant 55 and the issuing bank are not part of this exemplary embodiment of the invention. This exemplary embodiment includes electronically receiving a message including the ISO 8538 transaction amount field 1029, from restaurant 55; searching for a data item by using a content of ISO 8583 transaction amount field 1029; responsive to the searching step, electronically constructing a reply message; and electronically sending the reply message to restaurant 55.

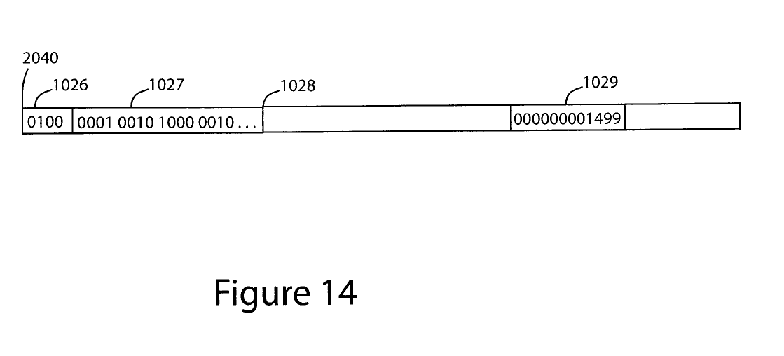

FIG. 14 shows message 2040, sent to an issuing bank, in more detail.

Benefits, other advantages, and solutions to problems have been described above with regard to specific examples. The benefits, advantages, solutions to problems, and any element(s) that may cause any benefit, advantage, or solution to occur or become more pronounced are not critical, required, or essential feature or element of any of the claims.

Additional advantages and modifications will readily occur to those skilled in the art. The invention in its broader aspects is therefore not limited to the specific details, representative apparatus, and illustrative examples shown and described. For example, a promotional offer could include a coupon, a loyalty event, a prepaid or partially prepaid voucher, or a promotional event requiring presence at a specific location, identification of specific item or person with a location, completion of certain number of transaction (frequency), completion of certain number of events outside of current location, etc.

A consumer could, upon request, receive a promotion by GPS location, by selecting menu category/item, or by selecting menu category/item via the Internet (home or mobile) or via a mobile App (e.g. App Store).

A consumer could, upon request, receive a promotion by GPS location, or by selecting menu category/item by selecting menu category/item via the Internet (home or mobile) or via a mobile App (e.g. App Store).

A customer could interact with a merchant by presenting a voucher, orally communicate a number, showing a clerk a mobile phone display, or waving a Near Field Communication (NFC) enabled device at a POS, for example.

Merchant action could include swiping a card thru a magnetic stripe reader, activating a keyboard or touch screen command to communicate a card number, waving a NFC enabled card a POS receiver.

The merchant may enter a promotion code, unique to the merchant, via a keyboard, as described above. The merchant may receive an account code, unique to the customer, via NFC circuitry.

A promotion authorization request may be routed to a front end processor, conventionally used for payment card transactions, and subsequently to a promotion server. A promotion authorization request may be routed from a front end processor, thru a network operated by a payment card association to a promotion server.

Communication between the merchant and the promotion server may be in the form of “authorization only”, i.e. only first part of normal credit card processing.

Requests declined by the promotion server may be for previously used or ineligible promotions. Requests authorized may be based on frequency, reward event, discount redemption, etc.

An exemplary system may notify the merchant with(i) a digital code (displayed or printed) on the POS or a device connected to POS; (ii) text of “authorized” or “declined”; (iii) ii plus additional text (e.g. “Return visit entitles customer to 20% discount on entree’).

To peruse, request, and receive promotions, a consumer may use an electronic device, such as a portable telephone, a smart cell-mobile phone, an iPad, a computer tablet, a laptop computer, a microcomputer or Personal Digital Assistant. The consumer may receive a promotion in an HTML document or an email, for example.

Although the consumers' devices have been disclosed as receiving promotion codes in the form of text, consumers' devices could receive promotion codes in a variety of data forms, including a digital form where the promotion code is not visible to the consumer, in a scheme where the consumer manipulates icons.

The merchant communicates authorization codes to the authorization server by manually swiping a merchant card, as disclosed above, or employing circuitry integrated into the merchant system, thereby relieving merchant personnel from performing steps dedicated to authorizing the promotion and conditionally effecting the promotion.

The consumer may communicate codes to the merchant and a variety of forms, including orally or electronically.

In the data structures shown in the Figures, lines represent a reference, such as a pointer, between one element and another. These references are not necessarily direct memory address pointers. Instead, more generally, each reference is a data entity, stored in association with one (referencing) element, that enables a processor to find a related (referenced) element. To physically address the referenced element, the processor may subject the reference to various translations or mappings.

Although the disclosed promotion processor locates the promotion ID field by using a bitmap within a message, a promotion processor could locate a promotion ID field by using a tag within the message. Alternately, a promotion processor could locate a promotion ID field by using an offset stored in the message. Alternately, a promotion processor could locate a promotion ID field by using an offset stored external to the message.

Accordingly, other departures may be made from the exemplary details disclosed above without departing from the spirit or the scope of Applicants' general inventive concept. The invention is defined in the following claims. In general, the words “first,” “second,” etc., employed in the claims do not necessarily denote an order.

What is claimed is:

1. A method for operating with a system including a first entity and a payment entity,
the first entity providing retail services, wherein the first entity effectively
sends an authorization inquiry message to the payment entity, the authorization inquiry message being in a first format; and
receives a reply message from the payment entity, the reply message being in a second format; and
the payment entity providing payment services, the payment entity performing the steps of
receiving a message, from the first entity, in the first format; and
responsive to the message received in the receiving step, constructing a message in the second format, such that a content of the message in the second format depends on whether an account of a consumer can effect payment,
wherein the method comprises the steps of:
electronically receiving an authorization inquiry message from the first entity, the authorization inquiry message being in the first format;
responsive to the message received in the receiving step, electronically constructing a reply message in the second format, such that a content of the message in the second format depends on whether a product promotional offer is applicable; and
electronically sending the reply message to the first entity, to cause circuitry in the first entity to behave as if the message came from the payment entity.

2. A method for operating with a system including a first entity and a payment entity,
the first entity providing retail services, wherein
the first entity activates
first circuitry that sends a message to the payment entity, the message including a first field, and
second circuitry that receives a reply message from the payment entity, the reply message being in a second format;
the payment entity providing payment services, the payment entity performing the steps of
receiving a message including the first field, from the first entity;
comparing the first field to a threshold;
responsive to the comparing step; and
constructing a message in the second format;
wherein the method comprises the steps of
electronically receiving a message including the first field, from the first entity;
electronically searching for a data item by using the first field;
responsive to the searching step, electronically constructing a reply message in the second format; and
electronically sending the reply message to the first entity.

3. A method according to claim 2 wherein the system further includes a routing system for receiving a signal and generating a network address in response to the received signal, the routing system including a plurality of wide area communication links, the routing system being configured with a first signal and configured with a second signal, wherein payment entity receives via the routing system, and the method step of receiving includes receiving via the routing system.

4. A method according to claim 3 wherein the system further includes a plurality of cards, the second signal being common to the plurality of cards, wherein the method further includes causing the routing system to be configured with the second signal.

5. The method of claim 2 further including the step of
locating the first field by using a bitmap within the message.

6. The method of claim 2 further including the step of
locating the first field by using a tag within the message.

7. The method of claim 2 further including the step of
locating the first field by using an offset stored in the message.

8. The method of claim 2 further including the step of
locating the first field by using an offset stored external to the message.

9. The method of claim 2 wherein the first field has a length of 12 decimal digits.

10. The method of claim 2 wherein electronically receiving an authorization inquiry message from the first entity includes receiving the authorization inquiry from a cashier station in the first entity.

11. The method of claim 10 wherein the cashier station includes a cash receipt drawer, a payment card reader terminal, a keyboard, and a display.

12. A promotion system for operating with a financial system including a first entity and a payment entity,
the first entity providing retail services, wherein
the first entity activates
first circuitry that sends a message to the payment entity, the message including a first field, and
second circuitry that receives a reply message from the payment entity, the reply message being in a second format;
the payment entity providing payment services, the payment entity performing the steps of
receiving a message including the first field, from the first entity;
comparing the first field to a threshold;
responsive to the comparing step; and
constructing a message in the second format;
wherein the promotion system comprises circuitry configured to
receive a message including the first field, from the first entity,
search for a data item by using the first field;
construct a reply message in the second format; and
send the reply message to the first entity.

13. A promotion system according to claim 12 wherein the financial system further includes a routing system for receiving a signal and generating a network address in response to the received signal, the routing system including a plurality of wide area communication links, the routing system being configured with a first signal and configured with a second signal, wherein payment entity receives via the routing system, and the circuitry in the promotion system receive via the routing system.

14. A promotion system according to claim 13 wherein the circuitry in the promotion system is configured to operate with a plurality of cards, the second signal being common to the plurality of cards.

15. The promotion system of claim 12 wherein the circuitry in the promotion system is configured to locate the first field by using a bitmap within the message.

16. The promotion system of claim 12 wherein the circuitry in the promotion system is configured to locate the first field by using a tag within the message.

17. The promotion system of claim 12 wherein the circuitry in the promotion system is configured to locate the first field by using an offset stored in the message.

18. The promotion system of claim 12 wherein the circuitry in the promotion system is configured to locate the first field by using an offset stored external to the message.

19. The promotion system of claim 12 wherein the first field has a length of 12 decimal digits.

20. The promotion system of claim 12 wherein the circuitry in the promotion system is configured to receive an authorization inquiry message from a cashier station in the first entity.

21. The promotion system of claim 20 wherein the cashier station includes a cash receipt drawer, a payment card reader terminal, a keyboard, and a display.

22. A promotion system for operating with a financial system including a first entity and a payment entity,
the first entity providing retail services, wherein
the first entity activates
first circuitry that sends a message to the payment entity, the message including a first field, and
second circuitry that receives a reply message from the payment entity, the reply message being in a second format;
the payment entity providing payment services, the payment entity performing the steps of
receiving a message including the first field, from the first entity;
comparing the first field to a threshold;
responsive to the comparing step; and
constructing a message in the second format;
wherein the promotion system comprises
means for receiving a message including the first field, from the first entity;
means for earching for a data item by using the first field;
means for constructing a reply message in the second format; and
means for sending the reply message to the first entity.

23. A promotion system according to claim 22 wherein the financial system further includes a routing system for receiving a signal and generating a network address in response to the received signal, the routing system including a plurality of wide area communication links, the routing system being configured with a first signal and configured with a second signal, wherein payment entity receives via the routing system, and the promotion system includes means for receiving via the routing system.

24. A promotion system according to claim 23 the promotion system includes means for operating with a plurality of cards, the second signal being common to the plurality of cards.

25. The promotion system of claim 22 wherein the promotion system is configured to locate the first field by using a bitmap within the message.

26. The promotion system of claim 22 wherein the promotion system is configured to locate the first field by using a tag within the message.

27. The promotion system of claim 22 wherein the promotion system is configured to locate the first field by using an offset stored in the message.

28. The promotion system of claim 22 wherein the promotion system is configured to locate the first field by using an offset stored external to the message.

29. The promotion system of claim 22 wherein the first field has a fixed length of 12 decimal digits.

30. The promotion system of claim 22 wherein the promotion system is configured to receive an authorization inquiry message from a cashier station in the first entity.

31. The promotion system of claim 30 wherein the cashier station includes a cash receipt drawer, a payment card reader terminal, a keyboard, and a display.
